(19) United States
(12) Patent Application Publication
(10) Pub. No.: US 2008/0304651 A1
(43) Pub. Date: Dec. 11, 2008

(54) System and method for overcoming dual tone multi frequency (DTMF) signal attenuation in analog and packet based networks

(75) Inventor: Amar N. Ray, Shawnee, KS (US)

Correspondence Address: PATTON BOGGS, LLP, 2001 ROSS AVENUE, SUITE 3000, DALLAS, TX, 75201, US

(73) Assignee: EMBARQ HOLDINGS COMPANY, LLC

(21) Appl. No.: 11/810,629

(22) Filed: Jun. 6, 2007

(51) Int. Cl. H04M 1/00

(52) U.S. Cl. 379/386

(57) ABSTRACT

A telephone may include a transmitter configured to transmit signals over a network a receiver configured to receive signals from the network a DTMF signal generator configured to generate DTMF signals, a DTMF gain adjustment module, and an amplifier module in communication with the DTMF signal generator and the DTMF gain selection module, where the amplifier module may be configured to amplify the DTMF signals. In one embodiment, the amplifier modules causes the DTMF signals to increase power by 10 dB so that DTMF signals being communicated over a network, possibly multiple packet networks, may be amplified if the DTMF signals are attenuated over the network and a remotely accessed telecommunications system, such as a voicemail system, cannot communicate with the telephone due to the attenuated DTMF signals.

### BACKGROUND

Telephony has been rapidly changing in recent years. With the development and growth of the Internet and other packet-based network types, communications carriers have been developing networks that either extend from the public switched telephone network (PSTN) or operate independent from the PSTN.

Remotely accessed telecommunications systems, such as voicemail, interactive voice response (IVR) systems, and interactive keypad response systems, generally use DTMF signals to enable a user to interact these systems. The remotely accessed telecommunications systems generally operate by recognizing and responding to DTMF signals having amplitudes with a certain power level range.

As new packet-based networks have been developing, additional equipment has been developed to interface telephones to the networks and the networks with each other. In addition, the packet networks tend to be smaller, which results in more network-to-network interfaces (NNI) being used.

As understood in the art, communications signals naturally attenuate when communicated through devices and over transmission lines. The amount of attenuation of communications signals is generally known for different types of network devices and networks.

FIG. 1 is an illustration of an exemplary network 100 composed of a PSTN 102, voice over broadband (VoBB) IP networks 104a-104c (collectively 104), and voice over Internet protocol (VoIP) peering network 106. Communications may be performed between the PSTN 102 and VoBB IP network 104 via media gateways 108a-108c (collectively 108). Communications between each of the sub-networks 104 and 106 are performed via session border controllers 110a-110c (collectively 110). As shown, communications between telephones may pass through the PSTN network 102 or avoid the PSTN network 102 by being routed directly to packet networks 104 and 106. Four exemplary call paths are shown in FIG. 1, including calls paths 1, 2, 3, and 4.

Call path 1 is a traditional call path that is established between a first telephone 112 that communicates via an access network 114 from the telephone 112 via a class 5 switch 116. The class 5 switch 116 routes the call via the PSTN network 102 to class 5 switch 118 via access network 119 to a receiving telephone 120. Call path 1 is considered a conventional call over the PSTN network 102 on plain old telephone (POTS) networks.

Call path 2 is shown to traverse via the access network 114, class 5 switch 116, and PSTN network 102. Call path 2 further is established over media gateway 108b to the VoBB IP network 104b via the Internet access device (IAD) 122 to telephone 124. Call path 3 is routed from the telephone 112 via the access network 114 and class 5 switch 116 to a border control switch (BCS) 126 to communicate via the VoIP peering network 106. From the VoIP peering network 106, the call path continues through session border controller 110b to the VoBB IP network 104b and via the IAD 122 to telephone 124.

In the case where a packet-based telephone 128 places a call to another packet-based telephone 124, call path 4, which passes through IAD 130 to VoBB IP network 104a. From the VoBB IP network 104a, call path 4 continues through SBC 110a, VoIP peering network 106, SBC 110b, VoBB IP network 104b, and IAD 122 to telephone 124.

With the traditional call path 1, each element over which the call path 1 is established has a known attenuation value. If a minimum low frequency component level starts at −10 dBm (low current=long loop), add about 7 dB loss (i.e., −7 dB) for each of 2 long loops, and include a 6 dB receive loss pad in the far end CO, the low frequency component power level is computed as −10−2×7−6=−30 dBm. The corresponding calculation for the high frequency component starts with a level of −8 dBm and includes an additional −4 dB twist for each loop, so the high frequency component power level is computed as −8−2×7−2×4−6=−36 dBm. For example, at the telephone 112, the low frequency DTMF component level is −10 dBm, access network 114 may have an attenuation of 7 dB, assuming no attenuation through class 5 switch 116, far end class 5 switch 118 has an attenuation (receive loss pad) of 6 dB, and access network 119 has an attenuation of 7 dB. In total, the attenuation of call path 1 is 20 dB for low frequency DTMF signal (i.e., a power level that is −20 dB below the DTMF signal power generated by the telephone). Therefore, the low frequency DTMF component power level at the far end telephone system may be −30 dBm.

The far end telephone system needs to recognize this low power level (−30 dBm), low frequency DTMF component for making an appropriate response. For the same path, the attenuation for the high frequency DTMF component of signal level −8 dBm turns out to be 28 dB (−2×7−2×4−6=−28 dB) including an additional −4 dB twist for each loop (i.e., the far end telephone system needs to recognize this low level (−8 dBm−28 dB=−36 dBm), high frequency DTMF component power level for making an appropriate response). It is to be noted that in traditional network, the levels of minimum low and high frequency DTMF signals received at the CO are −17 dBm and −19 dBm respectively with an attenuation of maximum −7 dB and −11 dB respectively. A DTMF signal that is attenuated by 20 dB to 28 dB may cause the remotely accessed telecommunications system to not receive DTMF signal inputs from the telephone to the remotely accessed telecommunications system properly. The other call paths, call paths 2, 3, and 4, pass over media gateways, broadband networks, IP networks, border control switches, Internet access devices, session border controllers, etc. Each of these network components have a range of attenuation that results from a signal passing through the respective network devices. For example, in addition to the amount of attenuation as stated above the broadband networks (e.g., VoBB IP network 104a) has an attenuation of 5 dB, central office (not shown) has an attenuation of 6 dB, media gateways have an attenuation of 6 dB, and integrated access devices have an attenuation of 6 dB. Each of these attenuations is a minimum value and the attenuation may have additional attenuation of a few dB. Because communications over multiple packet networks may occur, attenuation that is higher than conventional calls being placed over the PSTN network 102 may result. For example, if a telephone call is placed from a telephone and passes over multiple packet networks, such as call path 3, then attenuation resulting from the call being placed over multiple devices and multiple packet networks cause signals communicated over the call path to be attenuated by the sum of each of the attenuations of the network devices and networks over which the call path traverses. It is not uncommon that an attenuation of 30 dB or higher (i.e., −30 dB below the initial signal) occurs when a communication path crosses multiple packet networks.

As a result of higher attenuation occurring when a telephone call is placed from a conventional telephone via the PSTN network 102 to telephones operating on packet networks, operation of DTMF signals may be affected due to the attenuation of the high and low frequencies of the DTMF signals being attenuated below operational standards of remotely accessed telecommunications systems. For example, if a remotely accessed telecommunications system expects to receive DTMF signals with a minimum power level or amplitude of −38 dBm, a signal that is attenuated by 28 dB or higher may cause the remotely accessed telecommunications system to not receive DTMF signal inputs from the telephone to the remotely accessed telecommunications system properly. As more and more packet networks are established and integrated for use by telecommunications, higher levels of attenuation currently cause and are expected to cause more problems for users of telephones attempting to access remotely accessed telecommunications systems. For example, if a caller from India were to call a voicemail system in the United States, the voicemail system may be incapable of responding to DTMF signals from the caller in India due to the DTMF signals being attenuated to the point that the voicemail system cannot determine the DTMF signals being entered by a user pressing buttons on his or her telephone in India. What is needed is a way for DTMF signals traversing packet networks and network devices enable users to interface with remotely accessed telecommunications systems.

### SUMMARY

To overcome the problems of DTMF signals being attenuated by network nodes and packet networks to the point of not being able to communicate with remotely accessed telecommunications systems, the principles of the present invention provide for a user to amplify or otherwise increase DTMF signals at a calling telephone. The user may press a button to increase or amplify DTMF signals from that point forward during the telephone call. In one embodiment, the amplification may be by 10 dB. Alternatively, the user may press a sequence of buttons, such as “*62,” to cause the telephone to increase or amplify DTMF, signals for the remainder of the telephone call. To prevent the telephone from having problems with placing telephone calls due to power of DTMF signals being too high for a central office, for example, amplification of the DTMF signals may be reset after each telephone call or telephone calls in which amplification is increased.

In one embodiment, in accordance with the principles of the present invention, a telephone may include a transmitter configured to transmit signals over a network a receiver configured to receive signals from the network a DTMF signal generator configured to generate DTMF signals, a DTMF gain adjustment module, and an amplifier module in communication with the DTMF signal generator and the DTMF gain selection module, where the amplifier module may be configured to amplify the DTMF signals. In one embodiment, the amplifier module causes the DTMF signals to increase power by 10 dB so that DTMF signals being communicated over the network may be amplified if the DTMF signals are attenuated over the network and a remotely accessed telecommunications system, such as a voicemail system, cannot communicate with the telephone due to the attenuated DTMF signals.

One embodiment of a method for communicating DTMF signals from a telephone may include generating DTMF signals, amplifying the DTMF signals in response to a user selectively enabling amplification of the DTMF signals, and communicating the amplified DTMF signals over a network.

### BRIEF DESCRIPTION OF THE DRAWINGS

Illustrative embodiments of the present invention are described in detail below with reference to the attached drawing figures, which are incorporated by reference herein and wherein:

FIG. 1 is an illustration of an exemplary network including sub-networks for communicating telephone calls between end-users;

FIG. 2 is an illustration of an exemplary telephone for use in communicating DTMF signals with and without amplification;

FIG. 3 is an illustration of another exemplary embodiment of a telephone for communicating DTMF signals with and without amplification;

FIG. 4 is a block diagram of an exemplary schematic of a telephone for generating and communicating DTMF signals with and without amplification; and

FIG. 5 is a flow chart of an exemplary process for communicating DTMF signals with amplification in accordance with the principles of the present invention.

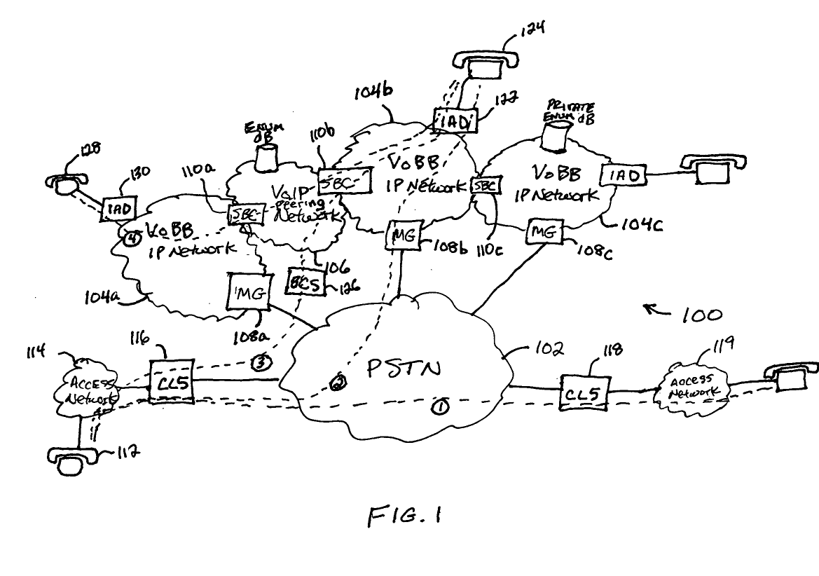

### DETAILED DESCRIPTION OF THE DRAWINGS

FIG. 2 is an illustration of an exemplary telephone 200 for use in communicating DTMF signals with and without amplification. The telephone 200 may include a keypad 202 that enables a user to dial telephone numbers and interact with remotely accessed telecommunications systems by pressing keys to generate DTMF signals for interacting with the remotely accessed telecommunications systems. In addition to conventional keys or buttons, such as volume control 204 and mute 206, a DTMF amplification key or button 208 may be included on the telephone 202. The DTMF amplification key 208 is a “hard-button” that causes the telephone 200 to amplify DTMF signals for communication over a network By amplifying the DTMF signals, the telephone 200 may properly interact with remotely accessed telecommunications systems if attenuation over a call path is such that a remotely accessed telecommunications system is incapable of identifying DTMF signals communicated from the telephone 200. Although shown as a button located on the face of the telephone, it should be understood that any other DTMF amplification selector may be provided on the telephone 200 or handset 210. For example, a gain adjustment mechanism that may be selectable by a user may include a hard-button, key, knob, switch, rotary mechanism, or any other mechanism located anywhere on the telephone 200, handset 210, or cord (e.g., cord 212) connected to the telephone 210 that enables a user to selectively amplify DTMF signals generated by the telephone 200 for communication over a network.

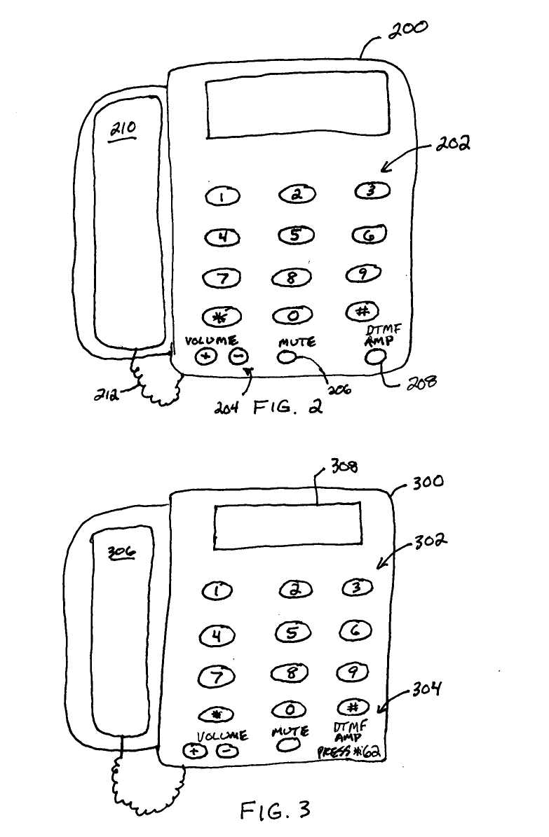

FIG. 3 is an illustration of another exemplary embodiment of a telephone 300 for communicating DTMF signals with and without amplification. The telephone 300 may include a keypad 302. Rather than having a hard-button, push button, or other independent selection mechanism for changing or otherwise increasing the gain of DTMF signals for communication over a network, the telephone 300 may enable a user to enter a code or sequence of keys, such as “*62,” to cause the telephone 300 to amplify the DTMF signals. Indicia 304 may be printed on the telephone 300 to notify the user of the key sequence to operate the DTMF amplification feature. The telephone 300 may use software, hardware, or firmware to recognize that the key sequence is pressed and cause the telephone 300 to amplify DTMF signals for the duration of the telephone call. In one embodiment, the telephones 200 (FIG. 2) and 300 may amplify the DTMF signals by a fixed amount, such as 10 dB, increase amplification of the DTMF signals in steps, such as step increases of 2 dB, or variable amounts in a more analog fashion. In one embodiment, indication of the amplification of the DTMF signals may be communicated to the user by increasing volume of DTMF signals via a speaker (not shown) in the handset 306 of telephone 300. The volume increase may or may not match the actual amplification increase of the DTMF signal to avoid damaging the speaker. Other indicators such as a single tone, light on the telephone, indicia on a display 308, or otherwise, maybe used to notify the user that the DTMF signals are being amplified.

FIG. 4 is a block diagram of an exemplary schematic 401 of a telephone 400 for generating and communicating DTMF signals with and without amplification. The telephone 400 may include a transmitter 402 and receiver 404. The transmitter 402 may be used for transmitting signals, including voice, data, and DTMF signals, and receiver 404 may be used for receiving signals, such as voice, data, and DTMF signals. In one embodiment, the transmitter 402 and receiver 404 are integrated into a transceiver, as understood in the art. A processor 406 may be in communication with the transmitter 402 and receiver 404 and execute software 407 to operate the telephone 400 in accordance with the principles of the present invention. In one embodiment, the software is configured to receive a signal from a user selecting or otherwise inputting a DTMF amplification request by pressing a hard-button or entering a code using a keypad 408 on the telephone 400.

The telephone 400 may include memory 409 that is in communication with the processor 406 for storing information, such as speed dial telephone numbers, other conventional information, and, optionally, one or more amplification levels for use in amplifying DTMF signals in accordance with the principles of the present invention.

A DTMF signal generator module 410 may be used for generating DTMF signals in response to a user pressing keys on a keypad of the telephone 400. A DTMF adjustment module 412 may determine that a user has selectively requested that DTMF signals be amplified or otherwise increased. A DTMF amplifier module 414 may receive DTMF signals 413 from the DTMF generator module 410 and, if the DTMF adjustment selection module 412 has determined that the user has requested that DTMF signals be amplified, amplify the DTMF signals 413. In one embodiment, the DTMF signals 413 are amplified by a constant amplification, such as 10 dB. Although shown as separate modules, the DTMF generator module 410, DTMF adjustment selection module 412, and DTMF amplifier module 414 may be part of the software 407 executed by the processor 406. Alternatively, and as shown, each of the modules 410, 412, and 414 may be hardware. Still yet, the modules may be firmware. While shown as separate modules, it should be understood that these modules may be incorporated into one or more modules and perform the same or similar functionality as described herein. It should be further understood that the term “module” does not limit a function to be independent of other functions and that the functions for performing the functionality for generating DTMF signals, adjusting DTMF signals, and amplifying DTMF signals may be integrated into a single hardware, software, or firmware module.

Although shown as a separate module, the DTMF adjustment selection module 412 may be any function that causes the DTMF amplifier to be activated to amplify the DTMF signals 413 from a non-amplified DTMF signal 415a into an amplified DTMF signal 415b. For example, the DTMF adjustment module may include a switch that is thrown in response to a user selecting to amplify DTMF signals, thereby causing the DTMF amplifier module 414 to amplify the DTMF signals during the remainder of the telephone call. The DTMF adjustment selection module 412 may disable amplification until a call is established. The DTMF amplifier module 414 may operate in two or more amplification levels, including amplification having a scale factor of one and amplification having a scale factor of any value that causes a DTMF signal to be amplified or otherwise increased. In one embodiment, the amplification is 10 dB. Amplification of the DTMF signals, for the purposes of the principles of the present invention, may be considered any function that causes the DTMF signals 413 to be increased by any predetermined power level, such as 10 dB. It should be understood that the schematic shown herein is exemplary and that any other configuration that enables the telephone 400 to operate in accordance with the principles of the present invention may be utilized.

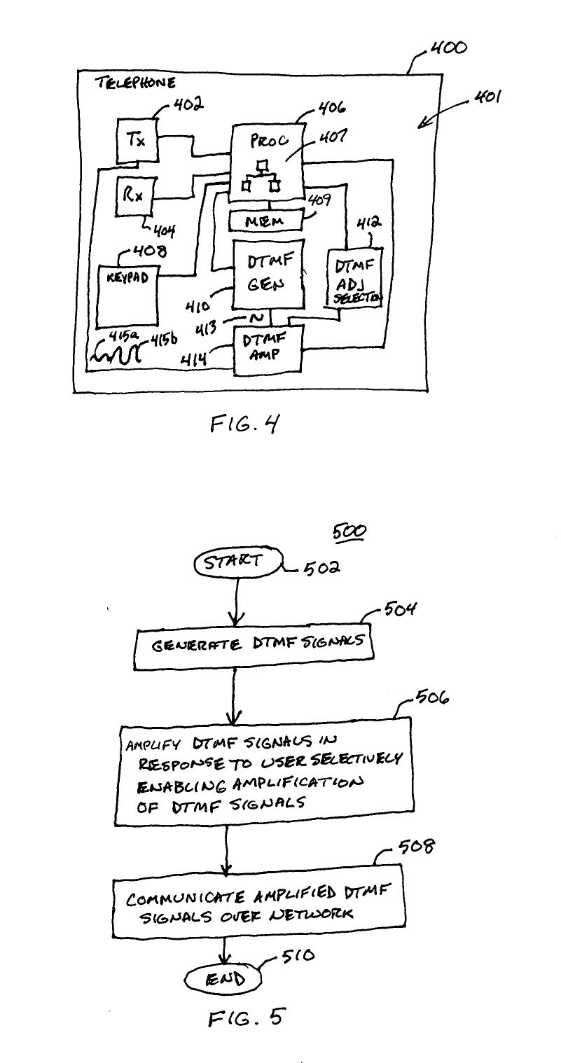

FIG. 5 is a flow chart of an exemplary process 500 for communicating DTMF signals with amplification in accordance with the principles of the present invention. The process 500 starts at step 502. At step 504, DTMF signals are generated. At step 506, the DTMF signals are amplified in response to a user selectively enabling amplification of the DTMF signals. Again, amplification may mean any function that causes the DTMF signals to be increased in gain, power, or amplitude. At step 508, the amplified DTMF signals are communicated over a network. It should be understood that the network may include one or more networks over which a call path is established between a telephone and remotely accessed telecommunications system. The process 500 ends at step 510.

The previous detailed description is of a small number of embodiments for implementing the invention and is not intended to be limiting in scope. One of skill in this art will immediately envisage the methods and variations used to implement this invention in other areas than those described in detail. The following claims set forth a number of the embodiments of the invention disclosed with greater particularity.

What is claimed:

1. A telephone, comprising:
a transmitter configured to transmit signals over a network;
a receiver configured to receive signals from the network;
a DTMF signal generator configured to generate DTMF signals;
a DTMF adjustment selection module; and
an amplifier module in communication with said DTMF signal generator and said DTMF adjustment selection module, said amplifier module configured to amplify the DTMF signals.

2. The telephone according to claim 1, further comprising a DTMF power adjustment mechanism in communication with said DTMF adjustment selection module to enable a user to adjust DTMF signal power.

3. The telephone according to claim 2, wherein said DTMF power adjustment mechanism is a push-button.

4. The telephone according to claim 1, wherein said DTMF adjustment selection module is configured, in a first state, to not cause said amplifier module to amplify the DTMF signals and, in a second state, cause said amplifier module to amplify the DTMF signals.

5. The telephone according to claim 1, further comprising a processing unit configured to execute said DTMF adjustment selection module and said amplifier module.

6. The telephone according to claim 1, wherein said DTMF adjustment selection module includes a switch.

7. The telephone according to claim 1, wherein said DTMF adjustment selection module is configured to reset said amplifier module after a telephone call during which said amplifier module is used to amplify the DTMF signals.

8. The telephone according to claim 1, wherein said amplifier module is configured to amplify the DTMF signals by 10 dB.

9. A method for communicating DTMF signals from a telephone, said method comprising:
generating DTMF signals;
amplifying the DTMF signals in response to a user selectively enabling the amplification of the DTMF signals; and
communicating the amplified DTMF signals over a network.

10. The method according to claim 9, wherein amplifying the DTMF signals includes amplifying the DTMF signals by 10 dB.

11. The method according to claim 9, further comprising receiving a change amplification signal to amplify the DTMF signals in response to the user selecting a user selection mechanism.

12. The method according to claim 11, wherein receiving the change amplification signal includes receiving the change amplification signal from a push-button.

13. The method according to claim 9, further comprising:
receiving a sequence of signals; and
determining that the user selectively enabled amplification of the DTMF signals in response to the sequence of signals matching a predetermined sequence of signals.

14. The method according to claim 13, wherein determining that the user selectively enabled amplification includes determining that the sequence of signals is associated with keys being pressed on a keypad.

15. The method according to claim 9, further comprising switching amplification of the DTMF signals off between calls.

16. The method according to claim 9, further comprising disabling amplifying the DTMF signals until after a telephone call is established.

17. A telephone system, comprising:
a transmitter configured to transmit signals over a network;
a receiver configured to receive signals from the network;
a DTMF signal generator configured to generate DTMF signals; and
means for amplifying the DTMF signals for communication over the network.

18. The telephone system according to claim 17, further comprising a means for enabling a user to selectively amplify DTMF signals.

19. The telephone system according to claim 17, further comprising means for resetting amplification of the DTMF signals between telephone calls.
